(19) United States
(12) Patent Application Publication
(10) Pub. No.: US 2013/0283227 A1
(43) Pub. Date: Oct. 24, 2013

(54) PATTERN REVIEW TOOL, RECIPE MAKING TOOL, AND METHOD OF MAKING RECIPE

(71) Applicants: Tsunehiro Sakai, Mito (JP); Yuichi Hamamura, Yokohama (JP)

(72) Inventors: Tsunehiro Sakai, Mito (JP); Yuichi Hamamura, Yokohama (JP)

(73) Assignee: HITACHI HIGH-TECHNOLOGIES CORPORATION, Tokyo (JP)

(21) Appl. No.: 13/978,114

(22) PCT Filed: Nov. 9, 2011
(86) PCT No.: PCT/JP2011/006249

§ 371 Date: Jul. 2, 2013

(30) Foreign Application Priority Data
Jan. 28, 2011 (JP) 2011-015902

(51) Int. Cl. G06F 17/50

(52) U.S. Cl. CPC G06F 17/50
USPC 716/136

(57) ABSTRACT

A recipe necessary for a review tool or the like to image an image is efficiently made in order to identify a cause of a failed position on the basis of a result of a failure analysis system.

A pattern review tool or a recipe making tool connected to the pattern review tool includes a recipe making unit which sets imaging conditions of an image so that the image is imaged along wiring including a failed position on the basis of wiring information including the failed position input from a failure analysis system connected to the pattern review tool through a network.

### TECHNICAL FIELD

The present invention relates to a pattern review tool that closely reviews a defect on a sample and a recipe making system that sets review conditions of the pattern review tool, for example, to an application that makes a recipe of the pattern review tool offline by using information obtained from a failure analysis support tool and an EDA (Electronic Design Automation) tool.

### BACKGROUND ART

In recent years, in the field of manufacturing semiconductor devices, failure analysis plays an important role to shorten development time of new devices/processes and maintain a high yield rate in mass production.

However, due to complicated device design to achieve high functionality and high performance of rapidly developing devices and refined manufacturing process of the devices, a ratio of systematic defects generated due to design layout and process margin increases instead of conventional randomly generated defects. It is highly probable that the systematic defect is also generated in lots manufactured after a lot in which a failure is detected, so that it is necessary to investigate the cause of the defect. However, the investigation of the cause of a failure when the failure occurs becomes more and more complicated as circuits are miniaturized and patterns are complicated.

Conventionally, as such a failure analysis, there are a physical review method that uses an emission microscope, a polarizing microscope, a scanning laser microscope (OBIC method/OBIRCH method), thermal emission microscope tool, and the like and a method that logically narrows down portions at which a failure is assumed to occur from design data, test pattern, test result, and the like by using a failure diagnosis tool by a software.

In a recent failure analysis support tool and the like, failed positions are narrowed down by combining a detection signal and design data (CAD) information obtained from these failure analysis tools and the failed positions are narrowed down for each wiring unit called a failure candidate net (wiring). PTL 1 describes a failure analysis tool that extracts the failure candidate wiring by using wiring information in a plurality of layers and performing an equipotential trace of wiring.

On the other hand, to investigate a cause of the failure, the failed portion is reviewed at high magnification by an electron microscope image or a pattern review tool that uses an optical image acquisition tool. The review conditions of the pattern review tool are set by an aggregate of a plurality of control programs that define an operation sequence of the tool. The aggregate is called a recipe. The operation sequence of the pattern review tool is defined by the recipe. As a tool that makes the recipe, for example, PTL 2 discloses a recipe making tool that uses design data. PTL2 describes a recipe making method in which a recipe is made by using design data, length values such as a pattern wiring width are measured from an image that is imaged based on the recipe, and a pattern shape is evaluated.

### CITATION LIST

### Patent Literatures

PTL 1: Japanese Patent Application Laid-Open No. 2007-335605 (U.S. Patent Application Publication No. 2007/0292018)
PTL 2: Japanese Patent Application Laid-Open No. 2006-351746 (U.S. Pat. No. 7,559,047)

### SUMMARY OF INVENTION

### Technical Problem

Basically, the position resolution of the above-described failure analysis tool is not so high. Therefore, it is difficult for the failure analysis tool to catch up with the miniaturization of semiconductor circuit pattern in recent years. Further, there are cases in which there is a plurality of wirings defined to be failed and a position at which failure is detected is not a direct cause of the failure. Therefore, significant time and efforts are required to identify the cause.

On the other hand, since the pattern review tool is a tool to acquire a high resolution image, the pattern review tool can detect a defective position or a failed position at a high position resolution. The inventor of the present application found that it is desirable to acquire an image of failure candidate nets and a coordinate position of a hot spot by the pattern review tool by using the failure candidate nets output from the failure analysis tool and coordinate information of the hot spot obtained from an EDA tool such as a lithography simulator in order to efficiently identify the cause.

However, since the pattern review tool is basically a tool to perform imaging at a fixed point position, it is necessary to repeatedly perform imaging by changing a field of view many times in order to detect a failure candidate position for each wiring unit. Further, the recipe setting is an operation performed by a human operator, so that it is necessary to manually perform an operation to set a large number of imaging position coordinates along wirings in order to detect a failure candidate position for each wiring unit. This troublesome operation is a bottleneck, so that, conventionally, the failure analysis tool and the EDA tool are not combined with the pattern review tool to perform failure analysis and defect detection.

Therefore, an object of the present invention is to provide a recipe making tool and a pattern review tool that can reflect information of a failed position on the review conditions of the pattern review tool.

### Solution to Problem

To solve the above problem, the pattern review tool or the recipe making tool connected to the pattern review tool sets imaging conditions of an image so that the image is imaged along wiring including a failed position on the basis of wiring information including the failed position input from a failure analysis system connected through a network.

### Advantageous Effects of Invention

By the above configuration, an image of a wiring path of high degree of risk can be reviewed by the pattern review tool on the basis of a result output from a failure analysis tool, so that it is possible to increase efficiency of identifying the cause of the failed position by the pattern review tool.

### BRIEF DESCRIPTION OF DRAWINGS

FIG. 1 is a diagram illustrating an entire configuration of an embodiment.

FIG. 2 is an entire configuration diagram of a review tool.

FIG. 3 is a diagram illustrating a flowchart of a tester, a failure analysis tool, and a failure analysis support tool.

FIG. 4 is a diagram illustrating nets by coordinates.

FIG. 5 is a diagram illustrating a state in which a net extends across layers in a layered structure of a semiconductor device.

FIG. 6 is a diagram illustrating a file format.

FIG. 7 is a diagram illustrating a flowchart of a first embodiment.

FIG. 8 is a diagram illustrating a flow when performing imaging while changing magnification according to the number of patterns in a field of view.

FIG. 9 is a diagram illustrating an imaging method when there is a circuit block in a net.

FIG. 10 is a diagram in which imaging is performed by making a recipe for each layer and tracing a path.

FIG. 11 is a diagram illustrating a flowchart of a second embodiment.

FIG. 12 is a diagram illustrating a screen on which nets and hot spots are displayed together.

### DESCRIPTION OF EMBODIMENTS

Hereinafter, a pattern review tool, in particular, a review tool according to the present invention will be described in detail with reference to the drawings. In the description below and the attached drawings, components having substantially the same function and configuration will be given the same reference numeral, and thus the redundant description will be omitted.

### First Embodiment

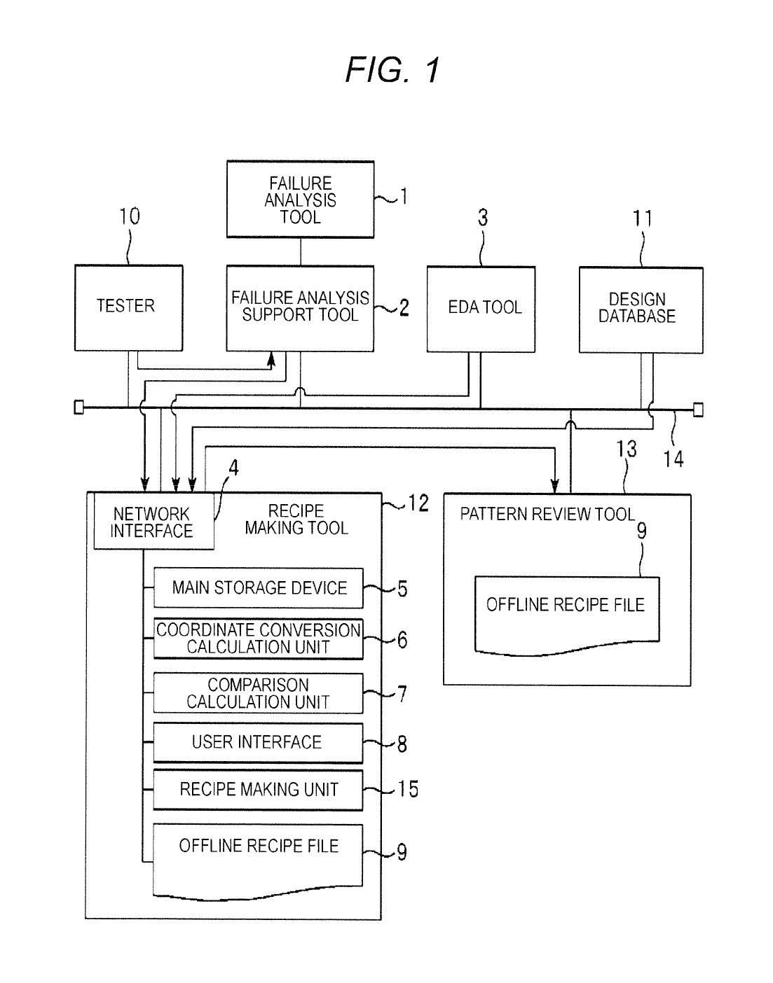

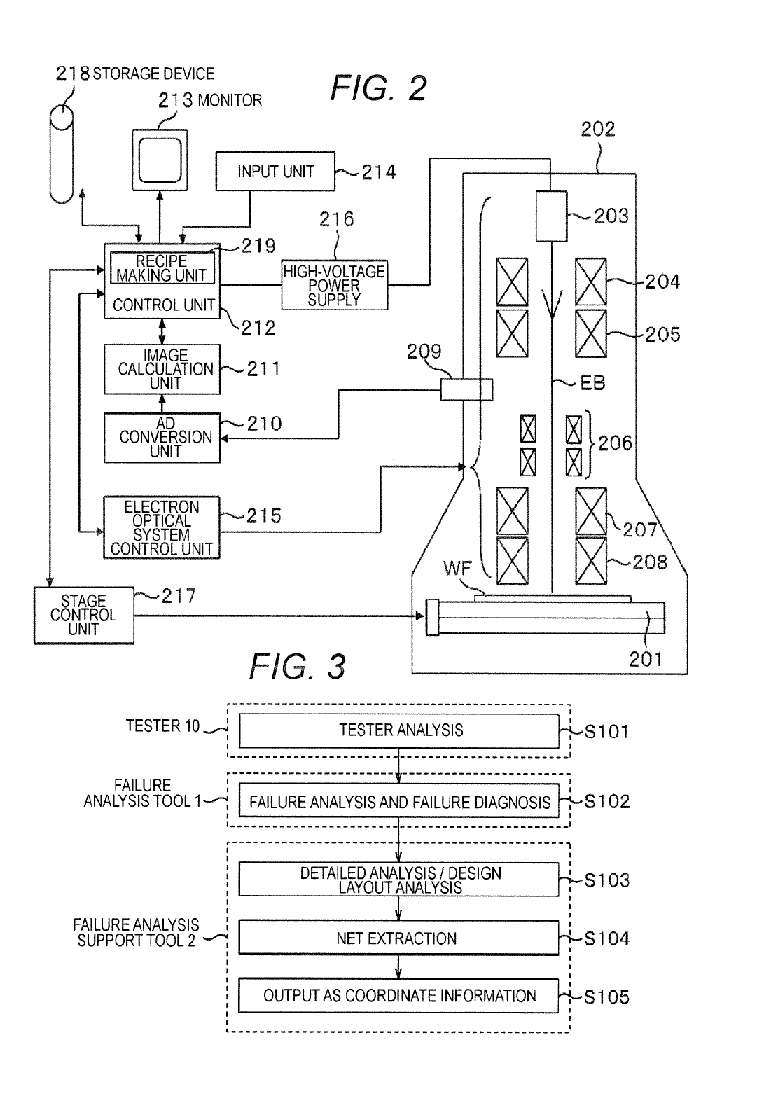

FIG. 1 is a diagram illustrating an example of a configuration of a semiconductor inspection system including a recipe making tool from failure analysis and an EDA tool according to the present embodiment. The system includes a failure analysis tool and a failure diagnosis tool (hereinafter referred to as a “failure analysis tool 1”), a failure analysis support tool 2, a tester 10, an EDA tool 3, a design database 11, a recipe making tool 12, and a pattern review tool 13. Hereinafter, tools that perform failure analysis, such as the failure analysis tool 1, the failure analysis support tool 2, the EDA tool 3, and the tester 10 and a tool that outputs a hot spot are collectively referred to as a failure analysis system. The pattern review tool 13 indicates a tool having a function to review a pattern in detail. As the pattern review tool 13, an SEM-based defect review tool is mainly used. However, an SEM-based defect inspection tool may also be used. In the description below, these tools are collectively referred to as a pattern review tool. The entire configuration of the pattern review tool 13 will be described in FIG. 2.

In the present embodiment, the recipe making tool 12 is connected to other tools through a network 14. A design database 11 is also connected to the network 14. The design database 11 stores design data of a semiconductor device.

The tester 10 is a tool that determines whether a chip is a non-defective chip or a defective chip from a result of an electrical test of a product in the last stage. The failure analysis tool 1 is a tool that narrows down a failed area of the chip that is determined to be a defective chip from the result of the tester. As the failure analysis tool 1, for example, an emission microscope can be used and information of a light-emitting image can be obtained. When an OBIRCH (Optical Beam Induced Resistance Change) tool is used, information of an OBIRCH image can be obtained. Alternatively, tools other than the above tools may be used as the failure analysis tool. The coordinate system of the failure analysis tool is a stage coordinate system of an inspection tool or the like and can have position information of a failed portion.

The failure analysis support tool 2 can hold the design data. After position adjustment between the design data and coordinate information obtained by the failure analysis tool is performed, it is possible to extract a position of a net (wiring) passing through an area of the failed position from design data information.

The EDA tool 3 is a tool that designs a circuit of a semiconductor and can hold the design data. The EDA tool 3 includes a function of a lithography simulator. This is because it is getting difficult to accurately form a pattern due to miniaturization of pattern and it causes a problem that final finishing dimensions are different from a design pattern. It is possible to extract a hot spot, where a defect easily occurs due to the dimension error, by simulation using the design data.

Net information obtained from the failure analysis support tool and hot spot information obtained from the EDA tool transmits data to the recipe making tool 12 through the network 14.

The recipe making tool 12 is comprised of a work station, a personal computer, or the like, and includes a means that makes a recipe necessary to review an area with a high degree of risk from data extracted by the failure analysis support tool 2 and the EDA tool 3. Here, the recipe represents a file in which review conditions of a review tool are set.

Specifically, the recipe making tool 12 includes a network interface 4 that transmits and receives data to and from other tools, a main storage device 5 that stores design data and coordinate information, a coordinate conversion calculation unit 6 that converts coordinate information and the like from the failure analysis support tool and the EDA tool, a comparison calculation unit 7 that associates areas, which are assumed to be located at the same coordinate position in different tools, with each other on the basis of converted coordinates, a user interface 8 including a keyboard, a mouse, and a display by which the coordinate information is displayed and an operator inputs instructions, an offline recipe file 9 that stores made recipes, and a recipe making unit 15 that makes a recipe on the basis of information input through the user interface 8 or the network interface 4. The recipe made here is transmitted to the pattern review tool 13.

These functional blocks may be formed by combining arithmetic processing circuits that perform processes of each unit (so-called hardware implementation) or may be realized by providing a memory (not illustrated) storing programs corresponding to processes of each unit in the recipe making tool or the pattern review tool and causing a processor of a computer connected to the recipe making tool or the pattern review tool to execute the programs. Alternatively, part of functional blocks may be realized by a dedicated processing circuit and the remaining functional blocks may be realized as software by programs and a processor. When the functional blocks are realized by programs, it is possible to upgrade the existing recipe making tool and pattern review tool by a storage medium storing the programs.

The pattern review tool 13 images a pattern path of a device to be reviewed on the basis of the recipe made by the recipe making tool 12.

A review tool using an SEM will be described as an example of the pattern review tool 13 with reference to FIG. 2. Position information of a defect is transmitted to the review tool from an appearance inspection tool that detects a defect. Further, one set of samples inspected by the appearance inspection tool is conveyed to the review tool. The review tool includes a sample storage means (not illustrated) that stores the conveyed one set of samples. Samples to be reviewed are sequentially selected from the one set of samples, moved to a sample chamber through a sample preparation chamber (not illustrated) of the review tool, and placed on a sample stage 201.

The review tool of the present example includes an imaging tool 202. The imaging tool 202 includes an electron source 203, an electron optical system described below, and the sample stage 201, which form an SEM.

The electron optical system that emits an electron beam EB includes condenser lenses 204 and 205, a deflection scanning coil 206, objective lenses 207 and 208, and a detector 209. The electron beam EB emitted from the electron source 203 is converged by the condenser lenses 204 and 205 and deflected by the deflection scanning coil 206 to scan the sample. Further, the electron beam EB is converged to a sample WF placed on the stage 201 by the objective lenses 207 and 208 and the electron beam EB irradiates and scans the sample WF. By this irradiation, secondary charged particles such as secondary electrons and reflection electrons having information of the sample are emitted from the sample WF and the secondary charged particles are detected by the detector 209. An output from the detector 209 is digitalized by an A/D conversion unit 210 and scanning positions of the electron beam are associated with pixels by an image calculation unit 211 and an image is generated. Further, if necessary, image processing such as defect extraction is performed by obtaining an image difference between an image to be inspected and a reference image which is an image of a normal portion corresponding to the defect position. An output from the image calculation unit 211 is transmitted to a monitor 213 through a control unit 212 which controls the entire tool and an SEM image of the sample WF is displayed. The image calculation unit 211 and the control unit 212 may be formed by a dedicated circuit board or may be realized by using a general-purpose computer.

The operation of the review tool in which an SEM image is imaged is instructed from the control unit 212 to each unit on the basis of a recipe that specifies the review conditions such as electron beam irradiation conditions and image acquisition conditions.

A user inputs input items such as defect review conditions and operation result monitoring conditions through an input unit 214 such as a mouse, a controller, and an operator console. Input parameters are transmitted to the control unit 212. The control unit transmits a control signal to an electron optical system control unit 215 that controls the lenses, the coil and the like included in the electron optical system and a high-voltage stabilized power supply 216 and sets imaging conditions of the SEM. Each unit of the above electron optical system operates on the basis of the imaging conditions.

Defect coordinate data from the inspection tool is transmitted to the control unit 212 through a network not illustrated and a review position is determined based on the defect coordinate data. According to another method, regarding the determination of the review position, a user may manually specify the review position through the input unit 214. Alternatively, relative position coordinates of the review position, which indicate a position from the origin in a die, may be set in the recipe in advance and a corresponding position in a plurality of dies may be automatically reviewed by executing the recipe. This method may be called a fixed point review.

The control unit 212 controls a stage control unit 217 on the basis of the determined review position. The stage 201 is moved in X and Y directions by the control of the stage control unit 217.

The control unit 212 includes a recipe making unit 219. The recipe making unit 219 makes a recipe on the basis of the imaging conditions specified by the operator through the monitor 213 and the input unit 214. Specifically, as described below, the imaging conditions indicate setting items for acquiring an image, which include a central position of an imaging FOV (Field of View), an FOV size, an imaging magnification, a resolution, and the like. The made recipe is stored in a storage tool 218 and can be read at the next review. The recipe may be made by the recipe making tool connected through the network as illustrated in FIG. 1. In this case, the review tool includes a network interface to receive a recipe from the recipe making tool.

Although an example in which a recipe is made by using the recipe making tool will be described below, the same process can be performed by the recipe making unit included in the review tool.

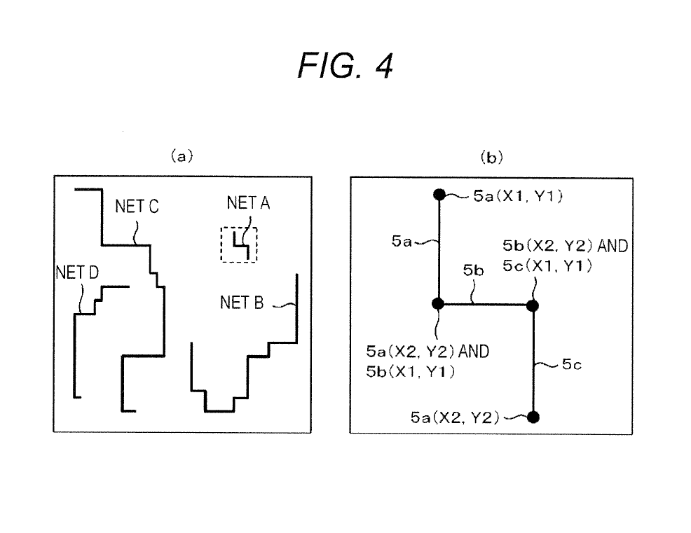

FIG. 3 is a diagram illustrating a flowchart of the tester, the failure analysis tool, and the failure analysis support tool.

In a semiconductor line, an inspection is performed by the tester 10 to check a final result of the product (S101). Here, an electrical test is performed and each chip is determined to be non-defective or defective.

To analyze the cause of the defect of the chip determined to be defective, a failure analysis tool that performs a light emission analysis using an emission microscope, an OBIRCH analysis using an OBIRCH tool, a thermal emission analysis using a thermal emission image analysis tool, and the like is used as the failure analysis tool 1. It is possible to obtain a detection signal of a failed position from the thermal emission, the light emission and the like by the failure analysis tool. Also, it is possible to obtain information of a failed position from design data, test pattern, test result, and the like by using the failure diagnosis tool (S102).

The failure analysis support tool 2 overlaps a coordinate position of a failed portion obtained in the failure analysis and the failure diagnosis (S102) and the design data and identifies an area of the failed position (S103).

Next, to narrow down a plurality of wiring patterns (nets) which may be failed, information of wiring patterns (nets) that pass through the area of the failed position is extracted (S104). Here, the information of wiring patterns (nets) includes position information of not only the wiring of a circuit formed on a die, but also patterns and the like formed on a sample such as line patterns and hole patterns. Normally, a semiconductor device is formed by laminating a plurality of layers and these patterns are connected not only in the same layer, but also over a plurality of layers. In the present embodiment, the pattern electrically connected as described above is called a net in general. An electrically connected wiring pattern is defined as one net.

An extracted net is output to the recipe making tool as coordinate information (S105). The coordinate information here may have any format if the coordinate information can specify the net. For example, coordinates of an end point and a bent point of the net may be output as a start point and an end point of a line. The line indicates a pattern of a substantially straight line portion that forms a net. One line is specified by a start point and an end point.

FIG. 4 is a diagram in which a net is specified by replacing coordinates of the end point and the bent point of the net by coordinates of the start point and the end point.

First, FIG. 4(a) is a net extracted by the failure analysis support tool 2. Nets A to D are extracted as failed nets. For example, a screen as illustrated in FIG. 4(a) is displayed on the failure analysis support tool. It is possible to display nets included in the entire chip as well as to display an enlarged image of a part of the nets by changing magnification.

FIG. 4(b) illustrates a method for converting the net information obtained by the failure analysis support tool 2 into planar coordinate information. Here, a part of the net A is enlarged and signal lines connecting terminals and connections between terminals are illustrated.

First, the net A is divided into straight lines and one divided straight line (line) is represented by the coordinates of the start point and the end point. In a case of a straight line 5a, coordinates of a start point 5a (X1, Y1) and coordinates of an end point 5a (X2, Y2) are managed as coordinate data. A straight line 5b and a straight line 5c are also represented as coordinate data of a start point and an end point. The net A is formed by a line group represented as described above. Therefore, if coordinates of the start points and the end points of straight lines which form a net are output to the pattern review tool or the recipe making tool, the net can be identified from the coordinates of the start points and the end points.

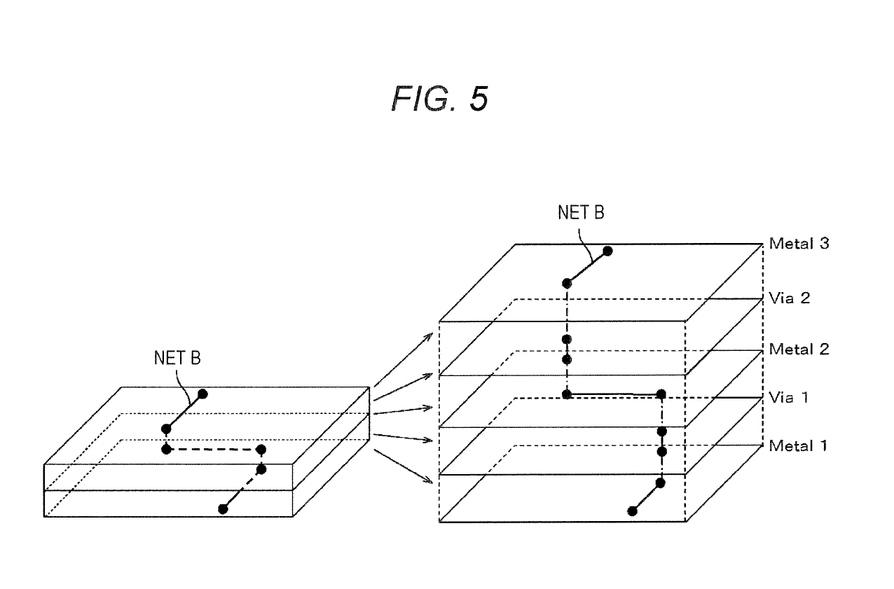

FIG. 5 is a diagram illustrating layers of start point and end point information of a net in a layered structure of a semiconductor device.

FIG. 5 is a diagram illustrating the net information in a layered structure.

A part of the net A is considered to be an example of a layered structure of a semiconductor device. As illustrated in FIG. 5, a five-layer structure including, from the lowest layer, a Metal 1 layer (Metal 1), a Via 1 layer (Via 1), a Metal 2 layer (Metal 2), a Via 2 layer (Via 2), and a Metal 3 layer (Metal 3) is considered.

Although a wiring process of only Metal 1, Metal 2, Metal 3 and the like can be displayed as a plane, the Via 1 layer which connects Metal 1 and Metal 2 and the Via 2 layer which connects Metal 2 and Metal 3 are connection layers which extend across processes, so that the connection layers cannot be represented by coordinates of the start point and the end point in only one layer. Therefore, as illustrated in FIG. 5, the layered structure needs to be resolved. Here, to make a recipe, the layers are resolved and each layer has corresponding coordinate (start point, end point) information. In other words, information specifying a layer is added to the coordinates of the start and end points, so that even a structure of a net that extends across layers can be specified by the coordinates of start and end points. For example, a hole shape in a connection layer which extends across processes such as a Cont layer and Via 1 is represented as information of points included in a plurality of layers. The information of points may be represented by the center coordinates of the hole shape or may be represented as a circular area by adding information of a radius of the hole or the like.

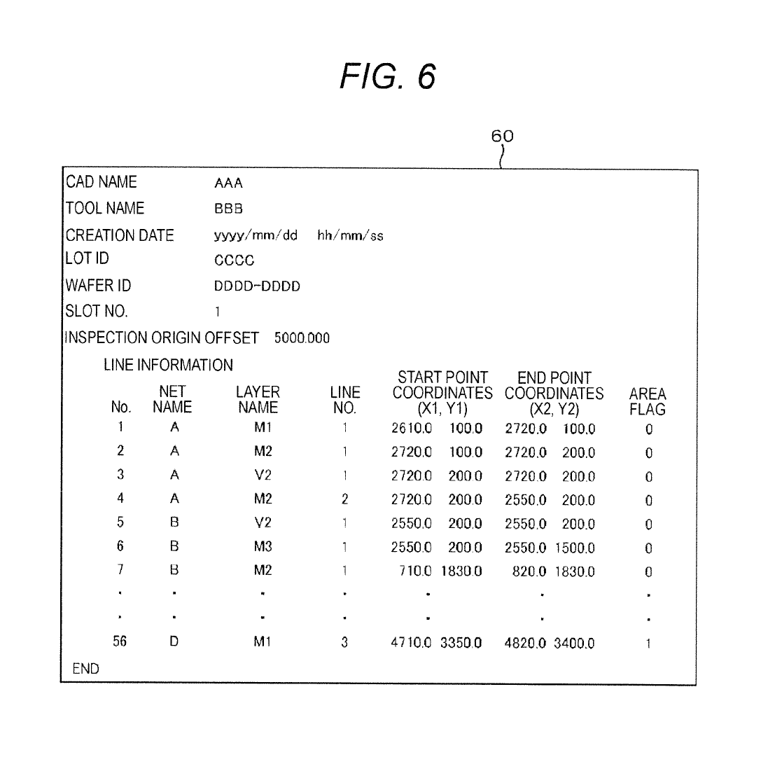

FIG. 6 is a diagram illustrating a file format transmitted from the failure analysis support tool 2 to the recipe making tool 12.

A file format 60 is a file which is made in association with a result of failure analysis and stores coordinate information corresponding to a net. For example, information used for the failure analysis, such as a CAD name and a tool name, information that specifies a wafer, such as a lot ID, a wafer ID, and a slot No. and other information such as the creation date and time and the inspection origin are stored as header information. Further, as information representing a failed net, information such as an extracted net name, a layer name that is required to determine a layer in a layered structure, a line No. that specifies a line after the net is broken down into straight lines (start and end point information), start point coordinates (X1, Y1) and end point coordinates (X2, Y2) of the line as a coordinate system, and the like is included. The net information is replaced by the start and end coordinates of lines and each net is managed by net name, so that in a file output from the failure analysis support tool, a plurality of pieces of net information can be included in one file and output. Further, information of a layer is added by the layer name, so that even a net that extends through a plurality of layers can be correctly described. The example illustrated in FIG. 6 is only an example. The file format may have any format if the file has information that can specify a failed net.

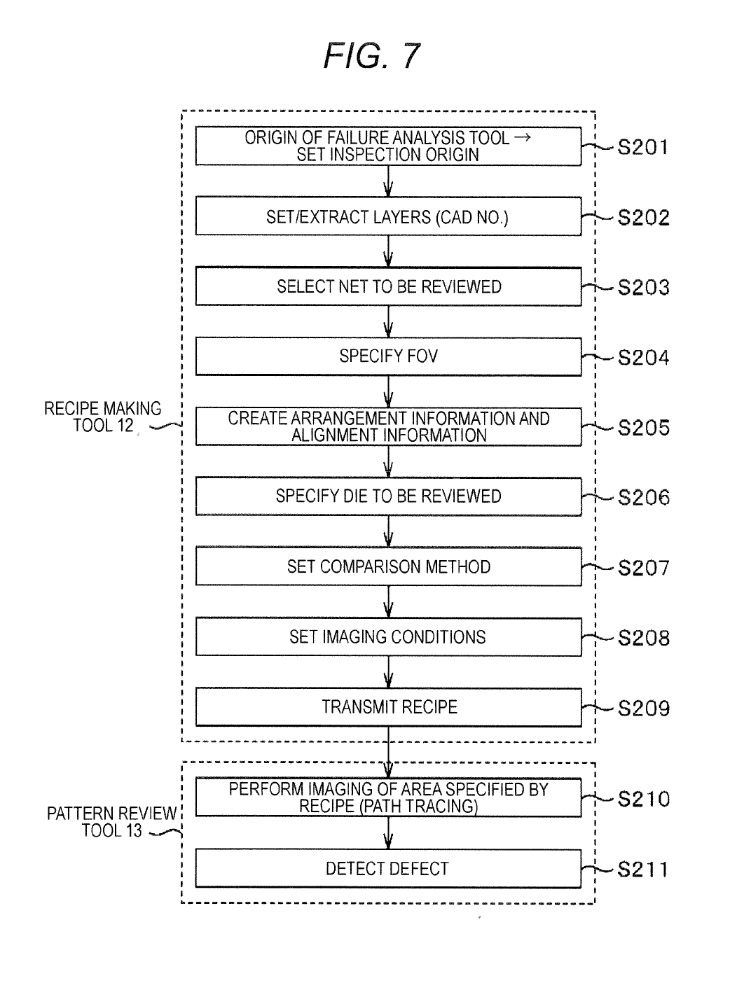

FIG. 7 is a diagram illustrating a flowchart of the recipe making tool in the first embodiment.

A procedure for making a recipe for performing so-called panoramic imaging in which images are acquired along wiring on the basis of wiring information obtained from the failure analysis support tool 2 will be described.

First, as an advance preparation, the recipe making tool acquires design data from the design database 11 through the network 14 and stores the design information in the main storage device 5 in the recipe making tool 12.

Next, information of nets including a failed portion is output from the failure analysis support tool 2 in a coordinate format illustrated in FIG. 6. The recipe making tool receives wiring information obtained by analyzing in the failure analysis support tool 2 through the network 14. Alternatively, necessary information may be acquired by requesting data from the recipe making tool to the failure analysis support tool 2.

If the origin used when the failure analysis tool performs analysis is different from the inspection origin or the origin is desired to be changed, the origin needs to be adjusted to the inspection origin to be used. The adjustment is performed by the coordinate conversion calculation unit 6. Here, the design data acquired in advance is displayed on the user interface and a user sets the inspection origin (S201). The inspection origin will be the origin coordinates used when an image is imaged later by the review tool, so that the inspection origin needs to be set.

Next, the comparison calculation unit 7 associates information indicating a layer which includes a failed net such as a layer name described in a file transmitted from the failure analysis support tool with information specifying a position on the CAD, such as a CAD No. and a data type of the design data. Thereby, the layer is set and the design data and the failed net are associated with each other. A layer name necessary to make a recipe is read from the file format, and necessary information such as CAD No. and data type is set. When a plurality of CAD numbers is used in one layer, a layer name and the plurality of CAD numbers are associated with each other. In the case of the layered structure, similarly, a plurality of layers to be used is set and associated (S202).

Next, a net to be reviewed by the pattern review tool is selected from a plurality of nets output from the failure analysis support tool 2 (S203). The nets output from the failure analysis support tool are displayed on a screen and an operator can select a net to be reviewed from the displayed nets. The display format on the screen may be a list format or a map format.

It is possible to set an FOV size (magnification) to be reviewed for the net selected by the user to be reviewed by the pattern review tool on an operation screen. It is possible to check and set an appropriate FOV size which does not exceed the FOV while checking a wiring size to be reviewed on the basis of the design data (S204). The magnification and the FOV size may be a fixed value or may be varied according to an imaging pattern as described below.

After the FOV size is determined, the center of imaging is determined by the recipe making unit 15. The failed portion input from the failure analysis system is not necessarily a defective position, but it may be considered that a defect actually occurs at another portion in the net that includes the defective portion. Therefore, the pattern review tool needs to acquire images along the net to be reviewed which is selected as described above and review the images. To image the entire path of the selected net without omission, the imaging center positions are set while shifting the position along the net at intervals corresponding to the FOV size. However, when the centers of imaging are set by the above method, images at a boundary between imaging areas are discontinuous. Therefore, considering a predetermined overlap area, it is more preferable that an interval is set by removing a size of the overlap area from the distance corresponding to the FOV size and the imaging center positions are set at the intervals. In this case, the overlap area may be specified by the user through the input unit of the recipe making tool or the pattern review tool in advance.

In summary, the imaging conditions are set so that images are imaged along the selected net. In other words, the imaging conditions are set so that any portion in the selected net is included in any one of a plurality of images imaged by one recipe. In other words, the imaging conditions are set so that the selected net is included in each image and boundary portions of adjacent images are in contact with each other or overlap each other by a predetermined amount. In other words, the imaging center positions are set so that the centers of imaging are set at a predetermined distance from the center position of an adjacent imaging area and the selected net is included in each imaging area. At this time, when the predetermined distance is smaller than or equal to the FOV size, the net can be reviewed without omission. On the other hand, when the predetermined distance is greater than the FOV size, some portions of the selected net may not be imaged. However, in an area where the defect occurrence rate is known to be extremely low in advance, it is possible to reduce the entire imaging time and improve throughput by setting in this way.

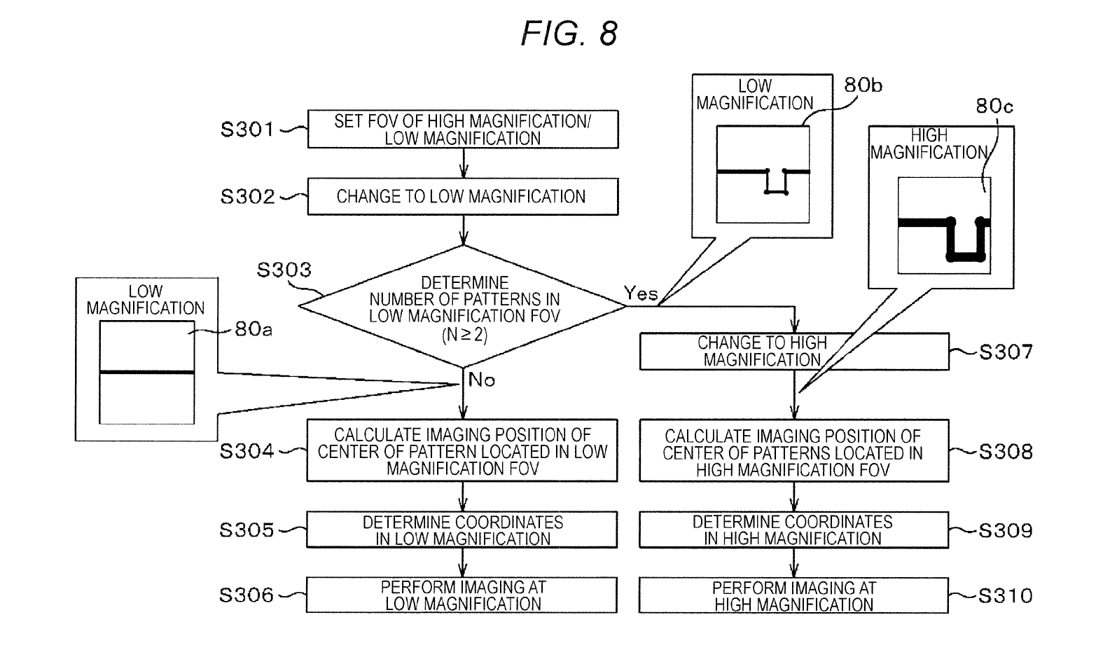

When an imaging area includes a bent point and the like of the net, the center of imaging is not necessarily shifted at intervals corresponding to the FOV size. When an imaging area includes a bent point, if the imaging is performed at a fixed magnification, the imaging is performed by using the bent point as the center of imaging, and if the magnification can be changed, as described later with reference to FIG. 8, the magnification is changed according to the number of lines included in the imaging area and the FOV size and the position of the center of the FOV are changed accordingly.

Next, the user creates arrangement information of dies on a wafer (arrangement information of dies exposed on the wafer) and thereafter registers wafer alignment information (image and coordinate information necessary to arrange a recipe according to an inclination of the wafer and the die size) (S205).

A die to be reviewed is selected to specify a pattern imaged in S204, in other words, after the position of the center of imaging and the FOV size are determined, a die to be reviewed is selected to specify a die from which the pattern is imaged (S206). The user performs this operation by specifying the die through the user interface. For example, when it is known in advance that the defect is easily occur in dies located at a circumferential portion of the wafer, a die located at a circumferential portion of the wafer may be selected. Since the die can be sampled and reviewed in this way, it is possible to efficiently perform the review. The user may set a selection method of the die to be reviewed by selecting the selection method from a plurality of modes registered in advance.

Next, the user sets a comparison method through the user interface (S207). When one die is set in the wafer, there is no reference image to be compared to detect a defect. Therefore, it is necessary to specify a comparison area, so that the user set a die comparison mode to acquire a comparison image. A defect can be detected from a comparison with the design data. By comparing with the design data, the comparison image needs not be imaged and the imaging time is shortened. However, in this case, image processing to change the design data closer to the actual image may be required. The image processing may be performed by the image calculation unit of the pattern review tool or the like.

Next, the imaging conditions such as the number of frames and the resolution when acquiring an image are set (S208).

When all the imaging conditions are set, the recipe is registered and the recipe is transmitted to the pattern review tool 13 through a communication network (S209). The recipe is stored in a recipe file in the pattern review tool 13.

In this example, an example is described in which the recipe is transmitted to the pattern review tool after the recipe is made by the recipe making tool. However, the recipe may be made by the computer of the pattern review tool as described above. However, when the recipe is made by the computer of the pattern review tool, the pattern review tool is occupied. Therefore, to improve the throughput, it is preferable to make the recipe offline by using the recipe making tool.

The pattern review tool 13 images a specified path on the basis of the stored recipe file (S210). When the images acquired by imaging the path as described above on the basis of the recipe are connected to each other, it is possible to panoramically image a failed net.

When the die comparison or the like is set, a defective position is detected from a difference from a reference die (S211).

FIG. 8 is a diagram illustrating a flow when performing imaging while changing magnification according to the number of patterns in the FOV. Here, an example in which two magnifications (low magnification and high magnification) are set will be described. Although the terms “low magnification” and “high magnification” are used in the description below, these terms may be replaced by “low resolution” and “high resolution” respectively.

Here, first, the operator sets the two magnifications of the low magnification and the high magnification while checking extracted net design data (S301). Next, the recipe making tool changes the magnification to the set low magnification (S302).

Next, whether or not there are two or more patterns (N≧2: N is the number of patterns) in an FOV of the low magnification is determined (S303). For example, the occurrence rate of systematic defect in a line pattern (80a) which is comprised of one straight line with no line or pattern being around is considered to be low, so that it is possible to reduce the number of images to be imaged as much as possible by performing imaging at low magnification.

When there is not a plurality of patterns (when there is one pattern), the coordinates of the center position of the pattern located in the FOV of the low magnification is obtained (S304). When the wiring is continuous, the imaging center position is obtained by considering the imaging area of the previous FOV. Next, the coordinates in the low magnification are determined (S305). The imaging is performed at the low magnification (S306).

When there are two or more patterns, the recipe making tool changes the magnification to the high magnification (S307). For example, in a portion (80b) which includes many bent points, in other words, in a portion which includes many lines and has high density, the possibility of occurrence of systematic defect may be high. Therefore, the pattern can be reviewed in detail by changing the magnification to the high magnification (80c).

Even when the number of patterns N in the FOV becomes one (N=1) after changing the magnification to the high magnification, the imaging is performed at the high magnification.

Next, the imaging center position is calculated so that the position of the center of imaging is the center of the patterns and lines included in the FOV of the high magnification (S308). When there is a plurality of patterns in the FOV, a position at which each pattern is evenly included is obtained. After the calculation, the image center position at the high magnification is determined (S309).

From S303 to S305 and from S308 to S309 are calculated by the recipe making unit and the calculation result is set in the recipe.

Next, the imaging is performed at the high magnification (S310). The imaged image is displayed on a display unit such as a monitor.

As described above, a straight line as illustrated in 80a is preferable to be imaged in the FOV of low magnification, and such a straight line is imaged in the FOV of low magnification. When a pattern includes a plurality of straight lines with bent points as illustrated in 80b, the pattern is preferable to be imaged at high magnification. In this case, the pattern is imaged at high magnification as illustrated in 80c, so that it is possible to set the magnification while considering the pattern in order not to miss a defect. Therefore, the imaging can be efficiently performed. Although an example in which two magnifications are used is described here, three or more magnifications may be used.

As described above, the magnification of imaging or the resolution can be varied according to the density of lines and patterns, so that a portion in which the possibility of defect occurrence is high can be intensively reviewed. Therefore, it is possible to image a defect at high magnification while ensuring the throughput.

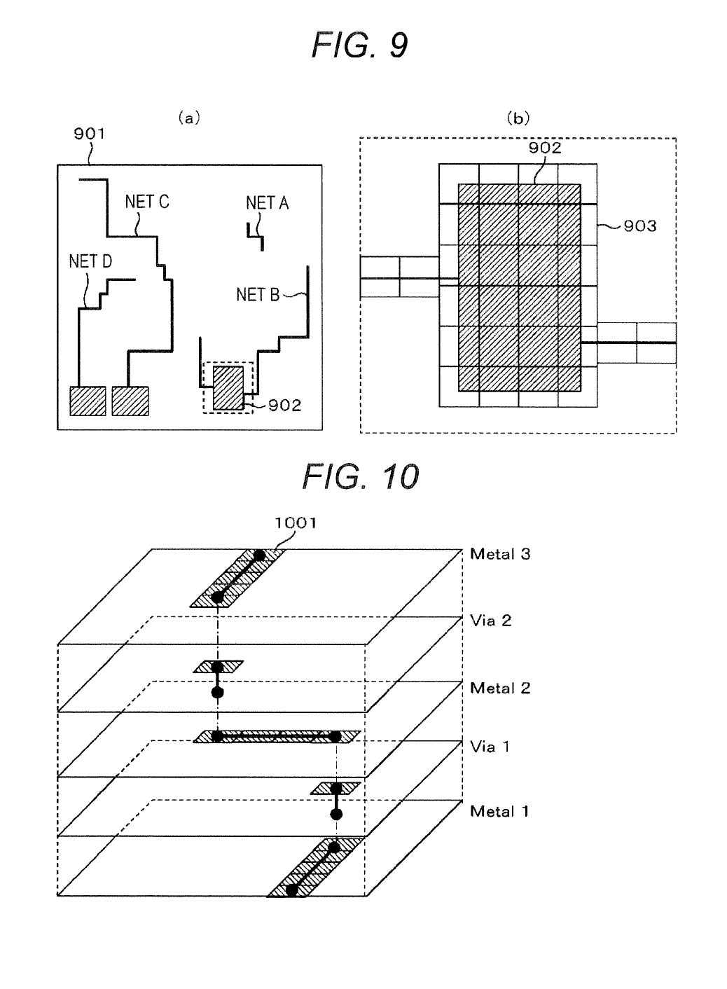

FIG. 9 is a diagram illustrating the imaging position when there is a circuit block and a cell area 902 in the net information. FIG. 9(a) is the net information extracted by the failure analysis support tool 2. For example, nets A to D are extracted. However, a part of the nets B and D is the circuit block 902, so that the information as a net (wiring) may not be obtained. A gray portion in FIG. 9(a) indicates the circuit block 902. In this case, as illustrated in FIG. 9(b), the imaging position is calculated from an imaging FOV 903 and an area for imaging the entire area of the circuit block is calculated so that the entire area of the circuit block 902 can be imaged.

When there is a circuit block, a flag is set in an area flag field in the format illustrated in FIG. 6, so that the line and the circuit block can be distinguished. Here, area information of the circuit block can be represented by displaying coordinates of two diagonal points of the four corners as the start point coordinates and the end point coordinates. For example, in the line information of No. 56 in FIG. 6, the area flag is 1. In this case, it is represented that an area of a rectangular shape defined by the start point coordinates (4710.0, 3350.0) and the end point coordinates (4820.0, 3400.0) is a circuit block.

FIG. 10 is a diagram illustrating an example in which a recipe is made for each layer and the path is traced. Reference numeral 1001 denotes a size of the field of view (FOV) corresponding to one image. Although in the examples in FIGS. 7 to 9, a net located in one layer is focused and described, as illustrated in FIG. 5, the net may exist across a plurality of layers. In this case, the recipe is made for each layer on the basis of the coordinate information resolved into each layer in FIG. 5. In other words, the net is resolved for each layer and the FOV size and the imaging center position are set by the method described in FIGS. 7 to 9 on the basis of each resolved net. At this time, even in a case in which the wiring information is represented by a point in each layer such as Via 1 and Via 2 and only one image is imaged, it is possible to acquire images along the wiring by performing the imaging along the nets which are present in the upper and lower layers and electrically connected. Thereby, the imaging across the layers can be performed.

As described in the first embodiment, the imaging conditions, for example, the imaging position and the imaging magnification, are set on the basis of the information of the failed portion from the failure analysis system, so that it is possible to preferentially review a portion in which the possibility of defect occurrence is high. Therefore, a defect can be efficiently identified. Further, even when a defect occurs in a portion other than the failed portion identified by the failure analysis system, it is assumed that a defect is present in a certain portion in the failed net, so that it is possible to efficiently identify the defect even in such a case by controlling the imaging position so that the imaging is performed along the net identified by the failure analysis system.

### Second Embodiment

In the present embodiment, an example will be described in which the imaging area is determined by using hot spot information obtained from a lithograph simulation of an EDA tool in addition to the net information output from the failure analysis tool described in the first embodiment.

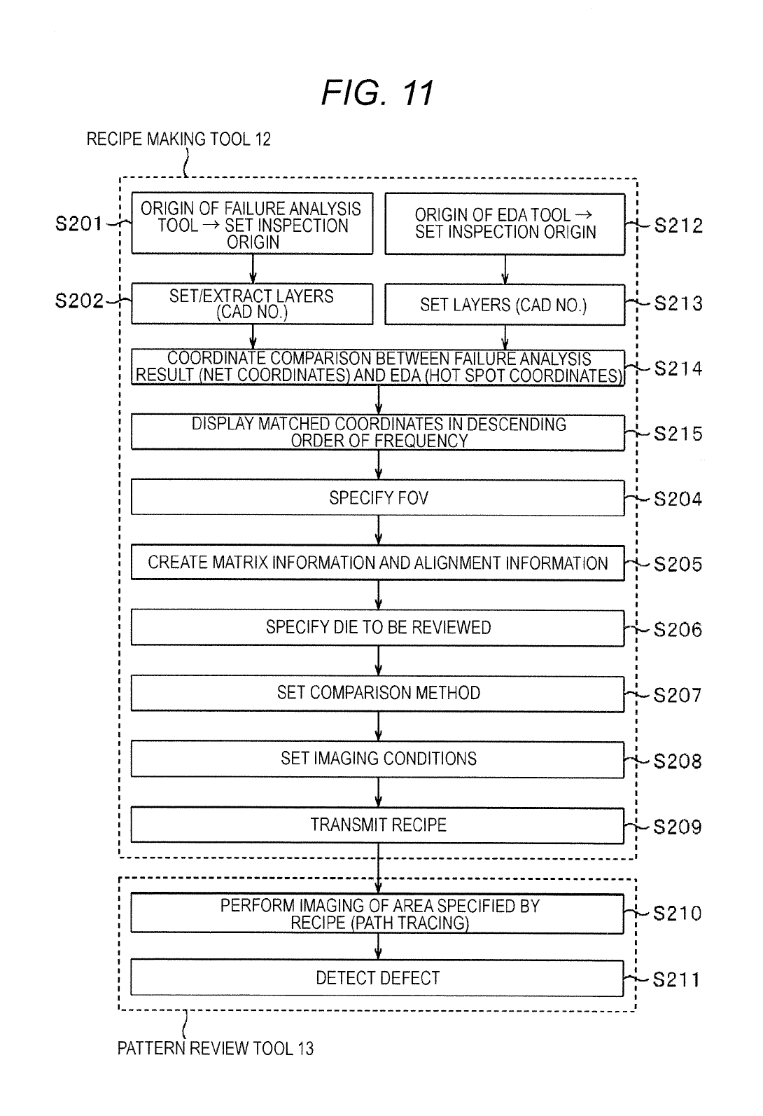

FIG. 11 is a diagram illustrating a flowchart of the recipe making tool in the second embodiment. Hereinafter, the description of the same portions as those in the first embodiment will be omitted. In FIG. 11, a procedure will be described in which a recipe is made on the basis of the hot spot information obtained from the EDA tool 3 along with the information obtained from the failure analysis support tool 2. The hot spot information is coordinate information of a portion in which the possibility of defect occurrence is high, which is obtained by a simulation.

In parallel with receiving the net information from the failure analysis tool, the hot spot information obtained by the lithography simulation of the EDA tool is input into the pattern review tool through an external interface. When the origin of the EDA tool is different from the inspection origin, the position of the inspection origin is adjusted by the coordinate conversion calculation unit (S212). The hot spot is output in a coordinate format from the EDA tool. In this case, the hot spot is compared with a result of the failure analysis support tool, so that the inspection origin needs to be equal to the inspection origin set in S201.

Next, the layer to be reviewed is set (S213). Here, the layer name needs to be same as that in the failure analysis tool.

The input of the information from the failure analysis tool and the EDA tool is completed, the comparison calculation unit 7 compares coordinates of the net information of the failure analysis and the information result of the EDA tool (S214). Since the origin of the failure analysis tool and the origin of the EDA tool are adjusted to the same inspection origin in S201 and S212, ideally, data from the failure analysis tool and the data of the EDA tool are compared at the corresponding coordinates and whether or not the failure analysis tool determines to be a failure and the EDA tool determines to be a hot spot at the corresponding coordinates may be determined. However, actually, even when the origins of the failure analysis tool and the EDA tool are set to the same origin, it is assumed that the coordinates determined to be a failure by the failure analysis tool and the coordinates determined to be a hot spot by the EDA tool are slightly different from each other. Therefore, it is preferable that a comparison range for comparing the coordinates can be set by considering the difference. The comparison range is the maximum value of the correction amount for correcting the difference between the coordinate system of the failure analysis and the coordinate system of the EDA tool. Specifically, among the failed portions output from the failure analysis tool, a failed portion included in a circle whose center is at the hot spot coordinates of the EDA tool and whose radius is within the comparison range is assumed to correspond to the hot spot coordinates. Thereby, even when a slight difference occurs due to tool errors, the defects are determined to be the same defect, so that the adjustment can be performed.

By comparing an output result of the failure analysis tool and an output result of the EDA tool, it is possible to extract a portion with a high degree of risk from the net output from the failure analysis tool. The portion of the true cause of the failure may not be included in the net output from the failure analysis tool, so that it is easy to investigate the true cause of the failure by the comparison described above.

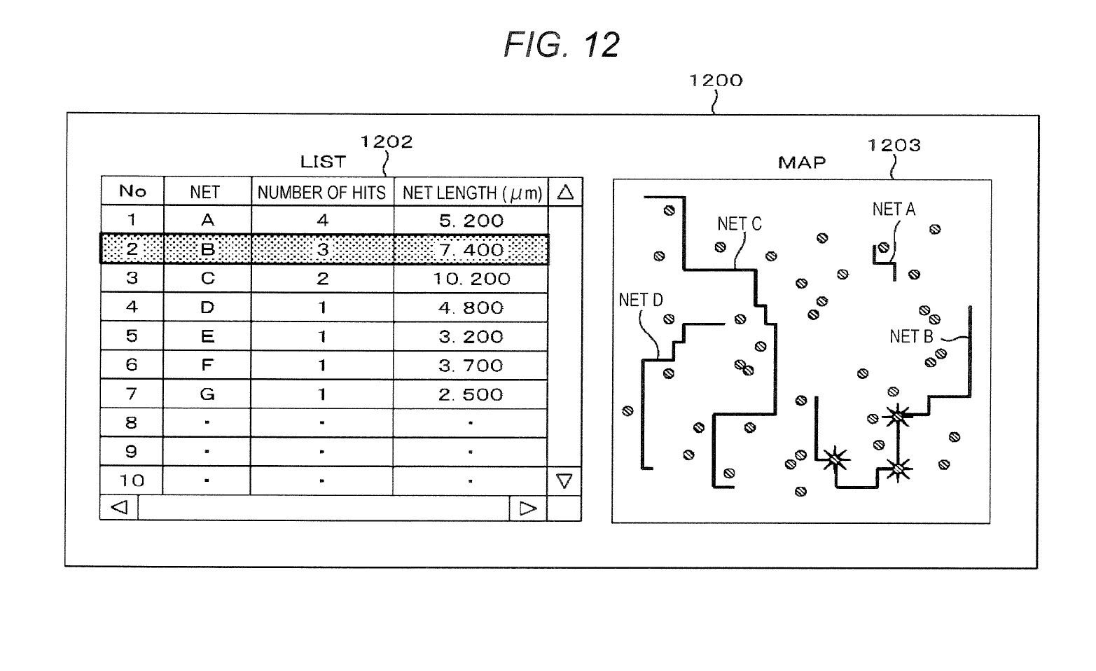

After the comparison in S214 is performed, the nets including many hot spots output from the EDA tool are displayed on the monitor in descending order of frequency, so that the nets can be displayed in descending order of the possibility of the failure (S215). Here, the operator can visually determine a net whose possibility of the failure is high at one glance of the list. The operator can select a net desired to be traced and imaged from the list. The display format of the list will be described later with reference to FIG. 12.

Next, in step S204, the FOV size is set by the method as described in the first embodiment (S204). After the FOV size is determined, the center of imaging is determined. As a determining method of the center of imaging, a method that determines the center of imaging on the basis of the hot spot information is considered in addition to the method described in the first embodiment. Specifically, the centers of imaging are set at large intervals by assuming that the possibility of defect occurrence is low in portions far from the hot spot in the selected net. In other words, the imaging center positions are set at intervals larger than or equal to an interval corresponding to the FOV size. Instead of or in addition to setting the centers of imaging at large intervals, the imaging may be performed at low magnification in a position far from the hot spot. When the imaging position is determined on the basis of the hot spot information as described above, it is possible to preferentially review a portion in which the possibility of occurrence of systematic defect is high.

In other words, the imaging interval on the net is set to be variable according to the imaging position, so that it is possible to efficiently detect a defect and improve the total through put.

As described in the first embodiment, the same effect can be obtained by performing the review by weighting the review magnification according to the imaging position.

The position of the center of the FOV and the review magnification are set by the recipe making unit 15.

The process after the net to be reviewed is determined is the same as that in the first embodiment, so that the description is omitted.

FIG. 12 is a GUI 1200 displayed on the user interface 8 in the recipe making tool 12. FIG. 12 is a diagram illustrating a GUI in which the nets output from the failure analysis support tool are displayed in descending order of the frequency of the coordinates of the hot spots of the EDA tool, which are included in the net. A list 1202 and a MAP 1203 are displayed on a display unit, which is the user interface of the recipe making tool.

In the list 1202, the number of the hot spot coordinates included in the net, which are obtained by the comparison performed in S206 between the net and the hot spot coordinates, for each net. The nets are displayed in descending order of the frequency, and the nets can be arranged in descending order of the degree of risk. The operator can appropriately select the net to be reviewed by referring to the information described above. In the list, the length of each net, the number of layers to be reviewed, the layer name, and the like can be displayed.

In the MAP 1203, the nets to be reviewed and the positions of the hot spots are displayed. The design data can also be superimposed and displayed. The display size can be enlarged or reduced.

For example, when the net B in the list 1202 is selected, in the MAP 1203, the net B is highlighted and the overlapping hot spot coordinates are blinking so that the positions are displayed in an easily recognizable manner. When the mouse is moved closer to the hot spot, the values of the coordinates can be displayed. When only a part of the selected net is desired to be imaged, if only a necessary part in the MAP is specified on the net, the coordinates of only the specified part can be output as an object to be imaged. In this way, the net to be imaged can be selected through the screen illustrated in FIG. 12.

As described above, the imaging position is determined by using the hot spot information in accordance with the net information as in the second embodiment, so that it is possible to efficiently select a net with a high degree of risk from a plurality of nets output from the failure analysis tool.

### REFERENCE SIGNS LIST

1 failure analysis tool
2 failure analysis support tool
3 EDA tool
4 network interface
5 main storage device
6 coordinate conversion calculation unit
7 comparison calculation unit
8 user interface
9 offline recipe file
10 tester
11 design database
12 recipe making tool
13 pattern review tool
14 network

1. A recipe making tool that makes a recipe used in a pattern review tool that emits an electron beam to a sample including a pattern and acquires an image, the recipe making tool comprising:
a recipe making unit which makes a recipe that sets review conditions of the sample in the pattern review tool,
wherein the recipe making unit sets imaging conditions of the image so that an image is imaged along wiring including a failed position on the basis of wiring information including the failed position input from a failure analysis system connected to the recipe making tool through a network.

2. A recipe making tool that makes a recipe used in a pattern review tool that emits an electron beam to a sample including a pattern and acquires an image, the recipe making tool comprising:
a computer which sets imaging conditions of the image so that an image is imaged along wiring including a failed position on the basis of wiring information including the failed position, which is input from a failure analysis system that can be connected to the recipe making tool.

3. The recipe making tool according to claim 1, wherein
the wiring information is coordinates of a start point, an end point, or a bent point of a line segment that forms the wiring.

4. The recipe making tool according to claim 1, wherein
the imaging conditions are an imaging center position of the image, an imaging path of the image, or an FOV area of the image.

5. The recipe making tool according to claim 2, wherein
the computer determines an imaging center position of an image from the wiring information and the FOV size of the image.

6. The recipe making tool according to claim 2, further comprising:
an input unit from which a user can select and input wiring to be imaged from a plurality of pieces of wiring information input from the failure analysis system.

7. The recipe making tool according to claim 2, wherein
the computer determines an imaging center position of an image from the wiring information and the FOV size of the image and makes a setting so that a plurality of images is sequentially imaged along wiring including the failed position.

8. The recipe making tool according to claim 2, wherein
the wiring information includes information of connection points between upper and lower layers of wiring existing across a plurality of layers, and
the computer acquires wiring information in the plurality of layers and at the connection points and sets the imaging position.

9. The recipe making tool according to claim 2, wherein
the computer determines an imaging interval of the image according to a hot spot obtained by a simulation in advance.

10. The recipe making tool according to claim 2, wherein
the computer overlaps coordinates of the wiring and hot spots obtained by a simulation in advance and determines an imaging position of an image on the basis of the number of the hot spots included in the wiring.

11. The recipe making tool according to claim 2, wherein
the computer determines an imaging magnification according to a density of patterns included in an FOV of the image.

12. The recipe making tool according to claim 2, wherein
the computer sets a cell area or a circuit block which overlaps the pattern as an imaging area in addition to an imaging area along the pattern.

13. A pattern review tool that emits an electron beam to a sample including a pattern and reviews a pattern, the pattern review tool comprising:
an electron optical system that emits the electron beam to the sample and detects secondary charged particles obtained by the emission;
an image calculation unit which generates an image of the sample from the secondary charged particles; and
a recipe making unit which makes a recipe that sets review conditions of the sample,
wherein the recipe making unit sets imaging conditions of the image so that an image is imaged along wiring including a failed position on the basis of wiring information including the failed position input from a failure analysis system connected to the pattern review tool through a network.

14. The pattern review tool according to claim 13, wherein
the wiring information is coordinates of a start point, an end point, or a bent point of a line segment that forms the wiring.

15. The pattern review tool according to claim 13, wherein
the imaging conditions are an imaging center position of the image, an imaging path of the image, or an FOV area of the image.

16. The pattern review tool according to claim 13, wherein
the recipe making unit determines an imaging center position of an image from the wiring information and the FOV size of the image and makes a setting so that a plurality of images is sequentially imaged along wiring including the failed position.

17. The pattern review tool according to claim 13, wherein
the wiring information includes information of connection points between upper and lower layers of wiring existing across a plurality of layers, and
the recipe making unit acquires wiring information in the plurality of layers and at the connection points and sets the imaging position.

18. The pattern review tool according to claim 13, wherein
the recipe making unit determines an imaging interval of the image according to a hot spot obtained by a simulation in advance.

19. The pattern review tool according to claim 13, wherein
the recipe making unit overlaps coordinates of the wiring and hot spots obtained by a simulation in advance and determines an imaging position of an image on the basis of the number of the hot spots included in the wiring.

20. The recipe making tool according to claim 2, wherein
the wiring information is coordinates of a start point, an end point, or a bent point of a line segment that forms the wiring.

21. The recipe making tool according to claim 2, wherein
the imaging conditions are an imaging center position of the image, an imaging path of the image, or an FOV area of the image.
